(19) United States
(12) Patent Application Publication
(10) Pub. No.: US 2004/0257649 A1
(43) Pub. Date: Dec. 23, 2004

(54) Combination window and video display with dual sided viewability

(76) Inventors: Kurt E. Heikkila, Marine of the St. Croix, MN (US); James B. Libby, Stillwater, MN (US)

Correspondence Address: WOMBLE CARLYLE SANDRIDGE & RICE, P.O. Box 7037, Atlanta, GA, 30357-0037, US

(21) Appl. No.: 10/758,855

(22) Filed: Jan. 16, 2004

Related U.S. Application Data
(60) Provisional application No. 60/440,957, filed on Jan. 17, 2003.

(51) Int. Cl. G03B 21/56

(52) U.S. Cl. 359/443

(57) ABSTRACT

A window is mounted in a wall between two adjacent rooms. The window has at least one suspended particle device glass pane that can be switched from a clear window mode to a partially reflective, partially translucent screen mode. A video image, such as a television program, can be projected onto the pane in its screen mode and is simultaneously viewable from either side of the pane and thus either of the two adjacent rooms. The window allows a parent in a kitchen, for example, to view continuously the programs children in an adjacent den are watching without physically leaving the kitchen to visit the den. The window screen provides dual room video program viewability without requiring multiple television sets.

### TECHNICAL FIELD

This invention relates generally to windows and more particularly to windows that selectively double as video monitors and video projection screens.

### BACKGROUND

Windows in homes and buildings have long served the purposes of allowing ambient light to enter a room and providing a view of the outdoors from inside the room. Recently, it has been realized that windows can be made to serve other heretofore unimagined purposes as well. For example, a window system can serve the traditional light and outdoor viewing purposes of windows, but also can double, when desired, as a video projection screen for a home entertainment center. In one embodiment of such a system, a bay window has a relatively large central window flanked by smaller side windows. The central window incorporates a pane of glass known as a “suspended particle device” or SPD. In the present disclosure, such glass is referred to as SPD glass. SPD glass incorporates millions of microscopic electro-optic particles, each of which can be made to be somewhat reflective. When an electric potential is applied to a SPD glass pane, the particles respond by aligning themselves in a single direction, which can be transverse to the plane of the pane. When the particles are in this transverse position, the glass pane appears substantially transparent and mimics a traditional glass window pane. However, when the electric field is removed, the particles revert to random orientations. This reversion causes the SPD glass pane to become substantially reflective. Such a reflective glass pane makes an excellent projection screen. Television programs, movies, and other video programming can be projected onto the screen and the window pane becomes a video monitor.

FIGS. 1 and 2 illustrate a system owned by the assignees of the present invention. FIG. 1 shows a bay window system functioning as a traditional window by allowing light to enter and providing outdoor viewing. The SPD glass in FIG. 1 has an electric potential applied thereto. FIG. 2 illustrates the SPD glass of FIG. 1 in an entertainment center mode with the electric potential removed. A video program, in this case a movie, is projected onto the large central SPD glass pane of the bay window system and the entire bay window functions as a home entertainment center. U.S. patent application Ser. Nos. 10/068,070 and 10/348,039 have previously been filed by the assignee of the present invention and disclose in detail the bay window/entertainment center illustrated in FIGS. 1 and 2. The entire disclosures of these patent applications are hereby incorporated by reference as if fully set forth herein.

In many households, and particularly households that include children, parents generally want to know what their children are watching on television at all times. This is not always convenient or possible because, in most homes, the television that children watch is in a den or other family room. Parents rarely can be in the room with the television and their children at all times. One parent, for example, could be in the kitchen preparing meals while the children watch television. While the parent may leave the kitchen to visit the den occasionally, the children are not supervised for a portion of the viewing time when the parent cannot be sure what the children are watching. Television security systems are available that can provide constant video surveillance in these situations. However, such systems are typically unsightly, expensive, and generally not suited to the non-commercial environment and decor within a home.

In addition to the need to monitor children's television viewing, it also is desirable in many instances to be able to watch television or a movie in more than one room of a house. This desire obviously can be met by installing separate television systems in each room. However, providing multiple television systems can be expensive, entail additional cable or satellite fees, and often occupy an inordinately large or awkward space in a room. Providing a separate television system, particularly a full size screen system, in, for instance, a kitchen, typically is not practical. In such an instance, homeowners often resort to small, hard-to-see, and, generally less than satisfactory, compact televisions in such rooms.

Accordingly, there is a need for a television system that allows a parent in one room to monitor continuously the programs children are watching in an adjacent room without being required to move from room-to-room. A related need exists in general to be able to monitor children in one room, e.g. a den, from another room, i.e. a kitchen. There also is a need for a system that provides full size video screen viewing in more than one room without installing two television sets and without taking up valuable space in one or both of the rooms. A further need exists for a video security or intercom system that can be installed in a home, that is aesthetically pleasing, that is not apparent when not in use, that takes up little or no space in a room, and that can allow a person to communicate visually with another person in another part of the home or outside of the home in a convenient manner. The present invention is primarily directed to the provision of a system that satisfies these and other needs.

### SUMMARY OF THE INVENTION

Briefly described, the present invention, in a preferred embodiment thereof, is an unique window and video monitor screen system that, when not in use as a video display, appears to be a standard clear window installed between two rooms, such as between the den and kitchen, of a home. The invention utilizes the SPD glass screen technology discussed above, illustrated in FIGS. 1 and 2, and described in detail in U.S. patent application Ser. Nos. 10/068,070 and 10/348,039, which have been incorporated by reference into the present disclosure.

A window incorporating at least one pane of SPD glass is installed between the two rooms, such as a den and an adjacent kitchen. In its normal or window mode, the pane is substantially transparent and provides a clear view from each room into the adjacent room. With the window in this normal mode, a parent in the kitchen can watch children playing, studying, napping or otherwise engaged in the adjacent den. When the children in the den want to watch television or a movie, the SPD screen can be switched to screen mode to become partially reflective and partially translucent. Video programming is then projected onto the screen and the window becomes a video entertainment center. It should be noted that the SPD glass pane of the window of the present invention generally becomes only partially reflective when switched to screen mode. In other words, the SPD glass pane becomes partially reflective and partially translucent. As a result, the television program or movie projected onto the screen, e.g. in the den, also is visible from the other side of the screen, e.g. from the kitchen. Even though the image is typically mirror image reversed as seen from the kitchen, a parent in the kitchen can nevertheless monitor continuously the program that children in the den are watching without leaving the kitchen. The image can, of course, be reversed to be regularly viewed from the kitchen, if desired.

In another operational mode, it may be desired simply to watch a television show or movie while preparing a meal or otherwise working in the kitchen. To accomplish this with the present invention, the window can be switched to screen mode and the projector activated to project the video program onto the screen, typically in mirror image reversed orientation relative to the den. In this way, the program can be viewed in normal orientation from the kitchen, on a full-size screen, and without the need to install a bulky and expensive second television set in the kitchen.

In yet another operational mode, the present invention might serve as the master screen of a household video surveillance system. In such a mode, small inconspicuous video cameras are installed in various rooms of the home or areas outside the home and images therefrom can be fed to the projection system. A person in a main room, e.g. the kitchen, can then instruct or otherwise control the system to project images from the video cameras onto the window/screen of the present invention to visually monitor activities in and around the home or interactively communicate with others from images and signals fed from security cameras.

The present screen also can be used in combination with other adjacent windows, which act as flat panel sound transducers or speakers for the television monitor.

The combination window and video display system described herein includes a switchable screen mounted between two adjacent rooms and being selectively switchable between a window mode, in which the screen is substantially transparent, and a screen mode, in which the screen is at least partially reflective. A projector is also included for projecting an image onto the screen when in the screen mode. The screen is selectively switched at a location remote from said screen by applying or removing an electrical potential.

A method of displaying a video program in two rooms simultaneously is disclosed and includes mounting a screen between the two rooms with the screen being partially reflective and partially translucent, and, displaying the video program on the screen such that the program can be viewed from either side of the screen and thus from either of the two rooms simultaneously. The screen is switchable from a window mode, where the screen is substantially transparent, to a screen mode, wherein the screen is at least partially reflective.

The window assembly described herein is installable in a wall separating two adjacent rooms of a building and includes at least one pane constructed of a material that is selectively switchable between a first mode, where the pane is substantially transparent to provide a view of each room from the adjacent room, and a second mode wherein the pane is at least partially reflective. The window assembly includes a projector for projecting an image onto the screen when the screen is in the second mode. The window assembly can include at least one pane of transparent material that is not switchable.

These and other features, objects, and advantages of this invention will become more apparent upon review of the detailed description set forth below taken in conjunction with the accompanying drawing figures, which are briefly described as follows.

### BRIEF DESCRIPTION OF THE DRAWINGS

FIG. 1 shows a bay window system that doubles as a home entertainment center in a “window” mode.

FIG. 2 shows a bay window system that doubles as a home entertainment center in an “entertainment center” mode.

FIG. 3 shows a window/video monitor system according to the present invention in a “window” mode installed and providing a view between two adjacent rooms of a home.

FIG. 4 shows the window/video monitor system of FIG. 3 in a “screen” mode and a projector for projection of a video image onto the screen.

FIG. 5 shows the window/video monitor system of FIG. 3 in the “window” mode as seen from the adjacent room.

FIG. 6 shows the window/video monitor system of FIG. 5 in the “screen” mode as seen from an adjacent room.

### DETAILED DESCRIPTION OF THE PREFERRED EMBODIMENTS

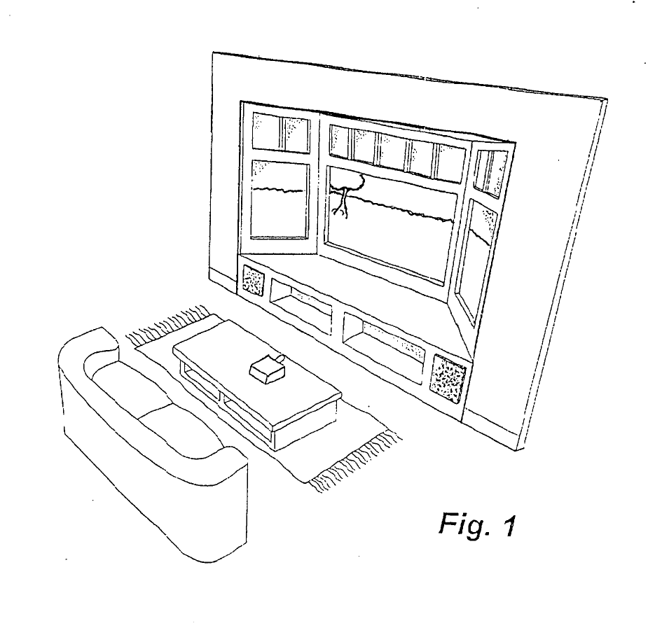

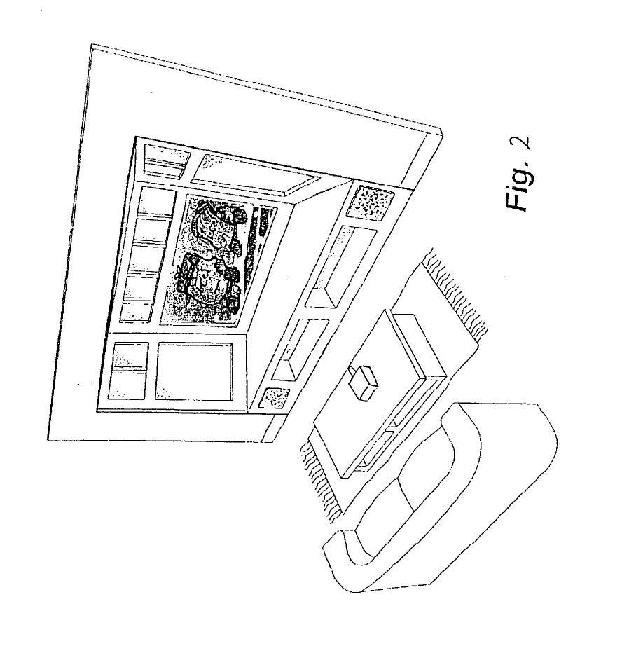

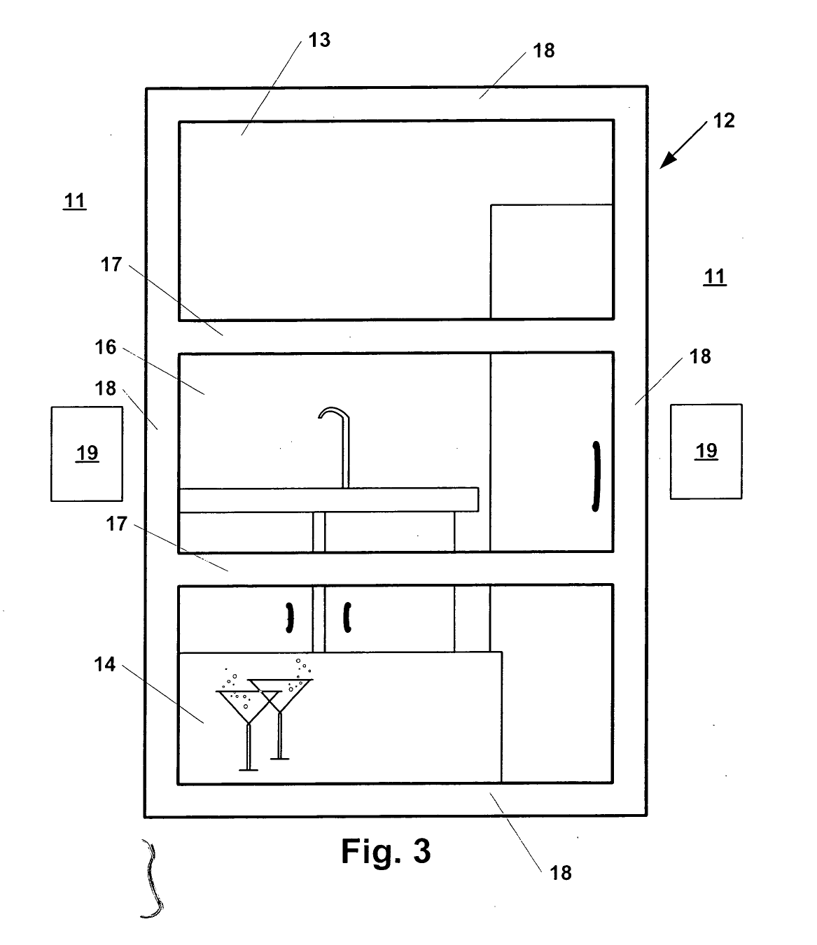

The invention will now be described in more detail with reference to the figures and more particularly with respect to FIGS. 3-6. FIGS. 1 and 2 provide general background for the discussion of the present invention and depict a combination bay window system that doubles as a home entertainment center. These figures depict a system that makes novel use of SPD glass technology as discussed above and as described in detail in the patent applications incorporated herein by reference. In FIG. 1 the window system is depicted in its “window” mode and in FIG. 2, the system is shown in its “entertainment center” mode with a movie being projected onto the central SPD glass screen of the window. FIGS. 1 and 2 illustrate one novel application of SPD glass technology.

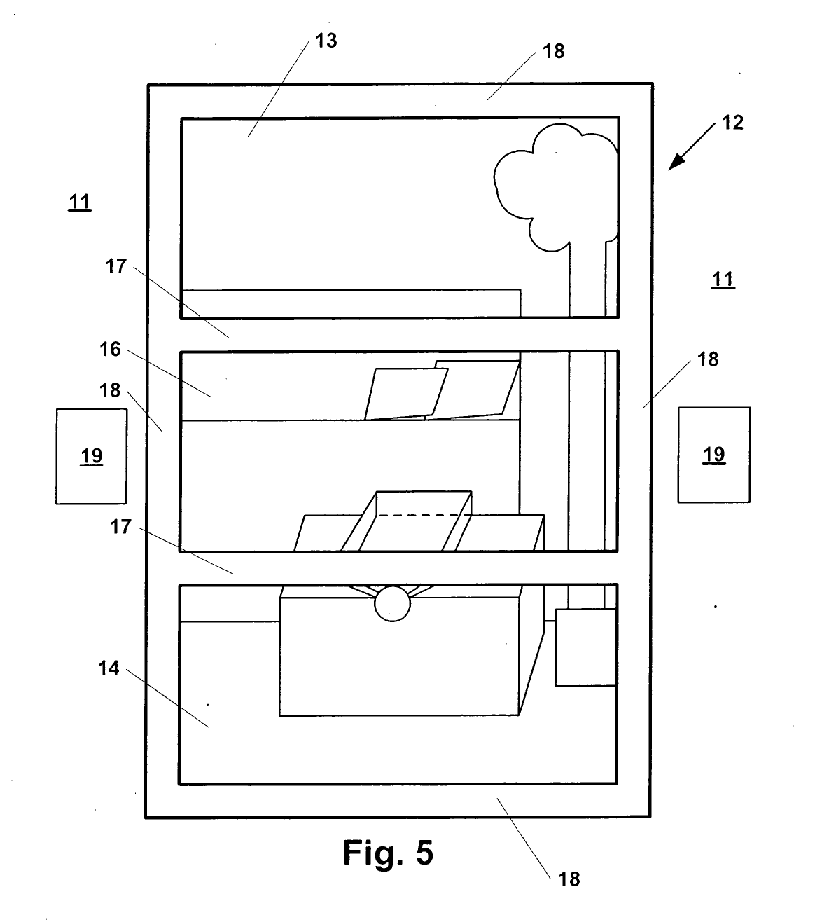

FIGS. 3-6 illustrate application of SPD glass technology in another novel way that embodies principles of the present invention. In FIGS. 3-6, a wall 11 separates two adjacent rooms of a home, which may be, for example, a family den and a kitchen. A window system 12 according to the invention is installed in the wall 11 and provides, in its “window” mode, a clear view from each of the adjacent rooms to the other. In FIG. 3, the view is from a den into an adjacent kitchen of a home with an opposing view (FIG. 5) being provided from the kitchen into the den. The window system 12 of the preferred embodiment has an upper pane 13, a lower pane 14, and a middle pane 16 separated by mullions 17 and all surrounded by a window frame 18. Of course, the invention encompasses other architectural window configurations and is not limited to the configuration of the preferred embodiment.

The upper and lower panes 13 and 14 in the preferred embodiment typically are made of standard window glass and each provides a permanent clear view between the two adjacent rooms. However, the central pane 16 in this embodiment is made of a pane of SPD glass that can be selectively switched between a “window” mode, in which it mimics a standard pane of glass, and a “screen” mode, in which it becomes a flat panel screen that is partially reflective and partially translucent. A pair of loudspeakers 19 is installed in the wall adjacent the window system 12 or elsewhere in the room(s) for reproducing the audio portion of a video program displayed on the screen. As an alternative to the traditional loudspeakers shown in FIGS. 3-6, audio also can be reproduced by one or more of the glass panes of the window system, such as upper or lower panes 13 or 14, when appropriate audio transducers are applied to the pane. Such glass panes as loudspeakers are described in U.S. patent application Ser. Nos. 10/068,070 and 10/348,039 incorporated herein by reference. Alternatively still, the audio, either speakers 19 or glass panes as flat panel speakers, can be used to play music, radio, or other audio when the middle pane 16 is in either the “window” or “screen” mode. In this alternative, for example, the user may opt to listen to the radio while viewing a program in “screen” mode whose audio portion has been muted or can listen to audio programming while the window is in its “window” mode. As a further alternative, upper and lower glass panes 13 and/or 14 can be SPD glass if desired for larger projections.

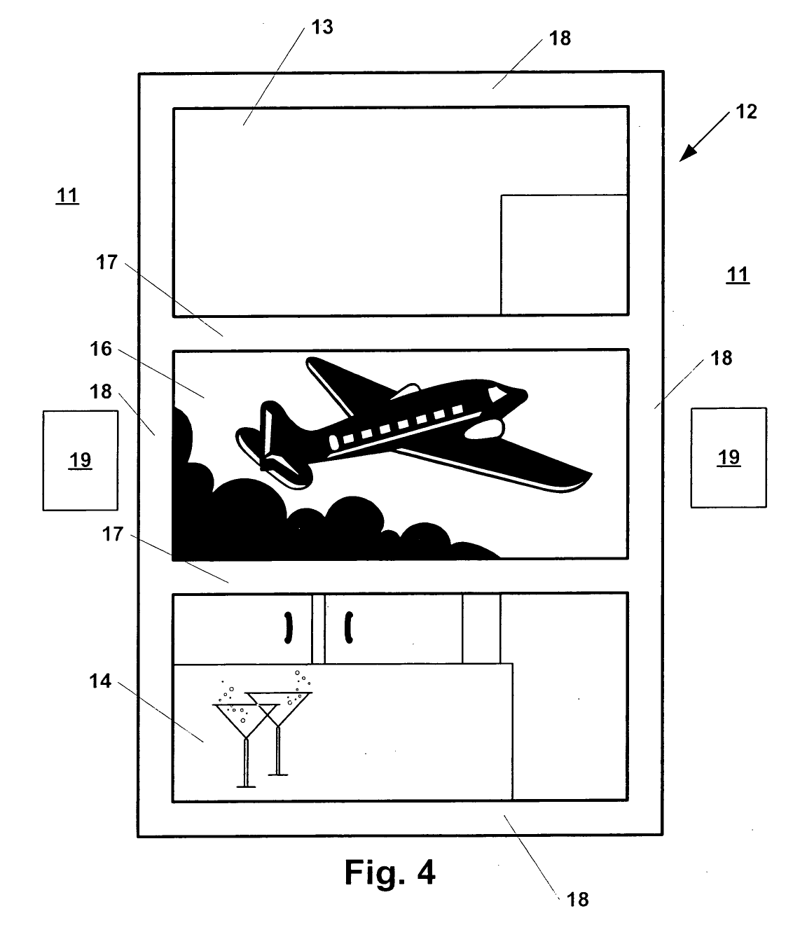

FIG. 3 shows the window 12 illustrating a video projection system 21 located, in this instance, in the den. The video projection system 21 is adapted and arranged to project, when activated, a video image onto the central pane 16 of the window 12 when the central pane is in its screen mode as shown in FIG. 4. In these circumstances, the projected video image is visible and can be viewed from the den in which the projector is located in a manner similar to a standard television screen or the bay window system disclosed in the incorporated patent applications. Thus, for instance, children or others located in the den can watch a television program on the central pane of the window. Furthermore, since the SPD glass of the central pane 16 is designed to be partially reflective and partially translucent, the same video image, albeit mirror image reversed, is visible from the other side of the window 12. In the illustrated embodiment, this reversed image is the view from the kitchen. Thus, the video program is visible simultaneously both from the den and the kitchen. Accordingly, a parent in the kitchen, in this example, has a continuous view of programs being viewed by children or others in the den. At the same time, the upper and lower panes 13 and 14 continue to provide a clear view from the kitchen of the children or others as they view the program in the den.

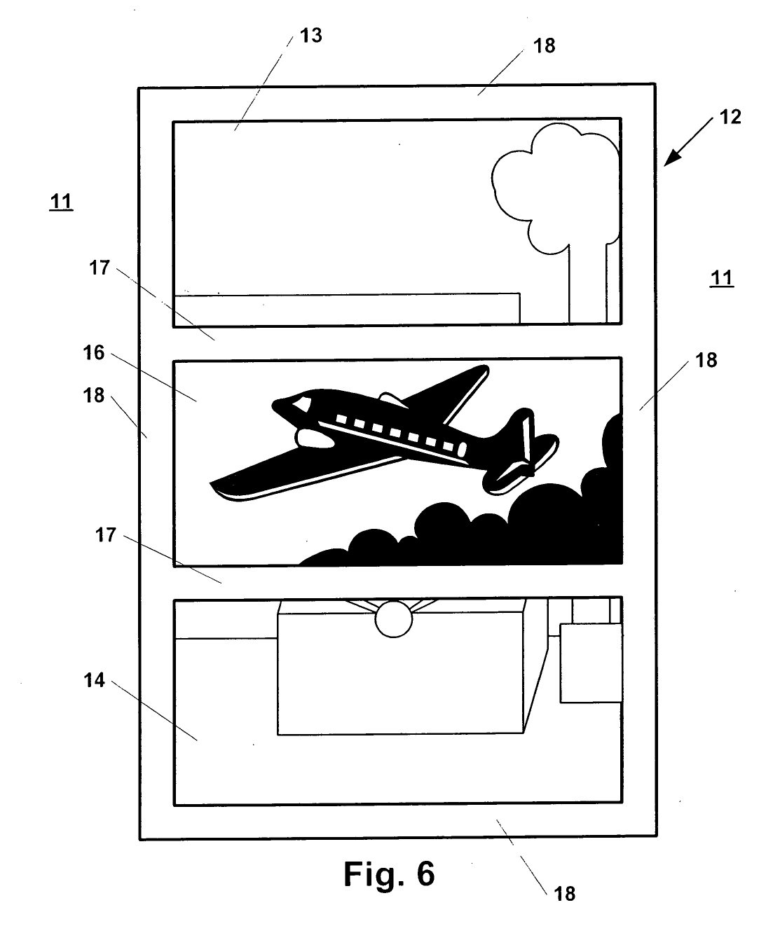

FIG. 5 shows the window system of this invention as seen from the adjacent room, e.g. the kitchen in the illustrated exemplary embodiment. From this perspective, the den and, in this view, the video projector system 21, are visible through the upper and lower panes 13 and 14 of the window and, with the central pane 16 in window mode, through the central pane as well. When the SPD glass of the central pane is switched to screen mode and the video projection system activated, the central pane becomes a partially reflective and partially translucent screen and the video image projected onto this screen from the den is visible on the central pane from the kitchen as shown in FIG. 6. At the same time, persons in the den can still be viewed directly through the upper and lower panes.

Although the projector is shown on a table in the den in FIG. 5, the projection system 21 can be disposed in any other feasible location, such as in another piece of furniture, in a ceiling, or in a wall. The projector also can be in the adjacent room, here the kitchen, with the image normally mirror image reversed to be viewed in the desired room, here the den. If the projector is disposed in the kitchen, it can be in the ceiling or floor, on a piece of furniture, on or in a cabinet, or concealed elsewhere.

In view of the foregoing description, the present invention addresses and solves the problems discussed in the Background section of this application, and other problems as well. For instance, a system is now provided that allows a parent in one room to monitor not only children in an adjacent room but also to monitor continuously the television programs the children are watching without physically visiting the adjacent room. The invention also provides multiple room television viewing without requiring a separate television set in each room. If one wishes to watch television in the den, for instance, the system is activated and viewed from the den. If it is desired to watch television from the adjacent kitchen, the video system need only be set to reverse the image projected on the screen, whereupon the television program is viewable in normal orientation from the kitchen. The system of this invention also may be incorporated into a home video security or intercom system wherein the video projection unit is received from cameras located in various parts of, or outside of, the home and the audio can be fed to the speakers. Persons in other parts of the home or outside can then be addressed, visually and/or audibly with appropriate intercom controls, with their images appearing on the screen and their voices heard in the audio speakers of the system of this invention.

Broadly speaking, therefore, the invention encompasses the method of displaying a video program in two rooms simultaneously comprising mounting a partially translucent partially reflective screen in a wall between the rooms and displaying, by projection or otherwise, a video image on the screen such that the image can be viewed from either room at the same time. In the preferred embodiment, the screen is a pane of SPD glass that can be selectively switched from clear window mode to translucent/reflective screen mode. However, the invention is intended to and should be construed to encompass any technology, now available or hereafter discovered, suitable for transforming a pane from a transparent mode to a reflective or screen mode.

The invention has been described herein in terms of preferred embodiments and methodologies. It will be clear to those of skill in the art, however, that various additions, deletions, and modifications might be made to the illustrated embodiments without departing from the spirit and scope of the invention as set forth in the claims.

We claim:

1. A combination window and video display system comprising:
a switchable screen mounted between two adjacent rooms;
said screen being selectively switchable between a window mode, in which the screen is substantially transparent, and a screen mode, in which the screen is at least partially reflective; and
a projector for projecting an image onto said screen when in said screen mode.

2. The combination window and video display system of claim 1 wherein said screen is mounted in a wall.

3. The combination window and video display system of claim 1 wherein said screen is a part of a window assembly.

4. The combination window and video display system of claim 3 wherein said window assembly includes at least one pane of glass in addition to said screen.

5. The combination window and video display system of claim 1 wherein said screen is selectively switched at a location remote from said screen.

6. The combination window and video display system of claim 1 wherein said screen is switched to the window mode by applying an electrical potential to said screen.

7. The combination window and video display system of claim 1 wherein the screen is switched to the screen mode by removing an electrical potential from the screen.

8. The combination window and video display system of claim 1 wherein said screen, when in the screen mode, is at least partially translucent so that a projected image can be viewed from either of the two rooms simultaneously.

9. The combination window and video display system of claim 1 wherein said screen is a suspended particle device.

10. A method of displaying a video program in two rooms simultaneously comprising the steps of:
(a) mounting a screen between the two rooms, said screen being partially reflective and partially translucent; and,
(b) displaying the video program on the screen such that the program can be viewed from either side of said screen and thus from either of the two rooms simultaneously.

11. The method of claim 10, wherein the video program is projected onto the screen.

12. The method of claim 10, wherein, prior to step (b), the method further comprises:
switching the screen from a window mode, where the screen is substantially transparent, to a screen mode, wherein the screen is at least partially reflective.

13. The method of claim 12, wherein the screen is disposed in a wall.

14. The method of claim 12, wherein the screen is a part of a window.

15. The method of claim 14, wherein the window includes at least one pane of glass in addition to the screen.

16. The method of claim 12, wherein the switching is performed remote from the screen.

17. The method of claim 12, wherein the switching is performed by removing an electrical potential from the screen.

18. The method of claim 12, wherein, after step (b), the method further comprises:
switching the screen from the screen mode to the window mode.

19. The method of claim 18, wherein the switching is performed by applying an electrical potential to the screen.

20. The method of claim 10, wherein the program displayed in a first room of the two rooms is a mirror image of the program displayed in a second room of the two rooms.

21. The method of claim 10, wherein the screen is a suspended particle device.

22. A window assembly for installation in a wall separating two adjacent rooms of a building, said window assembly comprising:
at least one pane constructed of a material that is selectively switchable between a first mode, wherein said pane is substantially transparent to provide a view of each room from the adjacent room, and a second mode wherein said pane is at least partially reflective; and,
a projector for projecting an image onto said screen when said screen is in the second mode.

23. The window assembly as claimed in claim 22 and wherein said screen, when in the second mode, is at least partially translucent so that the image is visible from each of said adjacent rooms.

24. The window assembly of claim 22 and wherein said screen is a suspended particle device.

25. The window assembly of claim 22 and further comprising at least one pane of transparent material that is not switchable.
